(19) United States
(12) Patent Application Publication
(10) Pub. No.: US 2026/0228899 A1
(43) Pub. Date: Aug. 6, 2026

(54) SYSTEMS AND METHODS FOR OBJECT MARKER DETECTION AND ASSESSMENT USING MACHINE LEARNING

(71) Applicant: ACUSHNET COMPANY, Fairhaven, MA (US)

(72) Inventor: Matthew B. RAPOZA, Middletown, RI (US)

(73) Assignee: ACUSHNET COMPANY, Fairhaven, MA (US)

(21) Appl. No.: 19/043,838

(22) Filed: Feb. 3, 2025

(51) Int. Cl. G06T 7/20; G06T 5/00

(52) U.S. Cl. CPC G06T 7/20; G06T 5/00; G06T 2207/30204; G06T 2207/30241

(57) ABSTRACT

In some implementations, a system may include an imaging device, at least one memory storing instructions, and at least one processor configured to execute the instructions to perform operations for identifying launch parameters. The operations may comprise receiving an image of an object captured by the imaging device. The operations may further comprise generating a refined image based on the received image, the refined image correcting one or more interfering features associated with the received image. Further, the operations may comprise analyzing the refined image using a machine learning model, the machine learning model being trained, using a plurality of object images, to recognize object markers in images received as input and identify one or more launch parameters based on the recognized object markers. Methods and networked devices are also described.

### TECHNICAL FIELD

The present disclosure relates generally to devices, systems, and methods for machine learning image processing and analysis, and more particularly to analyzing object markers using machine learning to improve the ability of a system to reliably identify various movement parameters based on the object markers.

### BACKGROUND

Machine learning is a subset of artificial intelligence that enables computers to learn and improve without explicit programming. It uses algorithms to analyze data and identify patterns, which are then used to create models that can make predictions or categorizations. Certain methods leverage machine learning for image processing tasks. Machine learning-based image processing combines image processing techniques with machine learning to identify objects in images and recognize patterns. Some applications of machine learning in image processing include pattern recognition, image identification, and marker recognition.

Image processing and recognition can help identify object markers within images, as well as launch parameters based on the identified markers within the images. Image processing and recognition may also aid in production control (e.g., by assisting during testing of golf balls or golf equipment in production). Image processing can be used to identify various parameters or markers associated with objects in various images (e.g., a golf ball, a club used to strike the golf ball, both the golf ball and the club used to strike it, another moving object, or multiple moving objects).

Current image processing techniques, however, have limitations for certain applications. For example, systems that rely on the processing of images having object markers may be affected by situations including but not limited to: (1) environmental variability (e.g., lighting conditions, graphics, glare, reflection), (2) blurry or poorly illuminated markers on the object(s), and (3) the need for frequent manual adjustment of configurations or settings (e.g., adjusting camera gain or another setting of an imaging device). The overall challenge thus becomes the maintenance or improvement of the robustness of current image processing techniques, but the underlying challenges may also include operating in dynamic, less-controlled environments (e.g., outdoors), and using fewer images (e.g., a few snapshots instead of continuous video footage of the object(s) as they move) without losing accuracy.

Furthermore, some image processing techniques are unable to distinguish a certain object marker from another, determinations can be subjective and based on the reviewing method or algorithm, and certain methods of image processing do not have the level of granularity required for accurate classification or assessment and thus ultimately require human intervention for accurate assessment.

The devices, systems, and methods consistent with the present disclosure solve one or more of the problems set forth above, or other problems of the prior art, with a new image processing technique that leverages machine learning methods to achieve a more accurate image processing result (e.g., evaluation or identification of object parameters). For example, the disclosed implementation of machine learning aspects to, e.g., determine object markers or launch parameters which are objective and consistent, thereby improving the processor(s) or computing device(s) described herein (e.g., making the processor(s) faster by not requiring individual assessment of the objects (or images thereof) in order to provide such parameters; or enabling the processor(s) to provide more accurate data based on the provided parameters, which are both more objective, more accurate, and more consistent as compared to the current state of the art).

### SUMMARY

Some aspects consistent with the present disclosure are directed to systems for identifying launch parameters. According to some embodiments, the system may include an imaging device, at least one memory storing instructions, and at least one processor configured to execute the instructions to perform operations for identifying launch parameters. In some embodiments, the operations may include receiving an image of an object captured by the imaging device. In some embodiments, the operations may further include generating a refined image based on the received image, the refined image correcting one or more interfering features associated with the received image. In some embodiments, the operations may also include analyzing the refined image using a machine learning model, the machine learning model being trained, using a plurality of object images, to recognize object markers in images received as input. In some embodiments, the machine learning model may further be trained to identify one or more launch parameters based on the recognized object markers. In some embodiments, the disclosed systems may be specifically configured to assess products based on identified launch parameters associated with those products.

Other aspects consistent with the present invention are directed to methods (e.g., computer-implemented methods) for identifying launch parameters (e.g., using image feature recognition). Consistent with disclosed embodiments, the method may include a step of receiving an image of an object captured by an imaging device. In some embodiments, the method may further include generating a refined image based on the received image, the refined image correcting one or more interfering features associated with the received image. In some embodiments, the method may also include analyzing the refined image using a machine learning model, the machine learning model being trained, using a plurality of object images, to recognize object markers in images received as input. In some embodiments, the machine learning model may further be trained to identify one or more launch parameters based on the recognized object markers. In some embodiments, the disclosed methods may be specifically configured to assess products based on identified launch parameters associated with those products.

Further aspects consistent with the present disclosure are directed to networked devices (e.g., computer servers) configured to execute operations for identifying object markers or launch parameters. In some embodiments, the networked device may include one or more processors to perform the operations for identifying launch parameters. Consistent with disclosed embodiments, the operations may include receiving an image of an object captured by an imaging device. In some embodiments, the operations may further include generating a refined image based on the received image, the refined image correcting one or more interfering features associated with the received image. In some embodiments, the operations may also include analyzing the refined image using a machine learning model, the machine learning model being trained, using a plurality of object images, to recognize object markers in images received as input. In some embodiments, the machine learning model may further be trained to identify one or more launch parameters based on the recognized object markers. In some embodiments, the disclosed networked devices may be specifically configured to assess products based on identified launch parameters associated with those products.

### BRIEF DESCRIPTION OF THE DRAWINGS

The foregoing and other aspects consistent with the present disclosure are best understood from the following detailed description when read in connection with the accompanying drawings. It is to be understood that the disclosure is not limited to the illustrated or disclosed embodiments. Included in the drawings are the following Figures:

FIG. 1 is a block diagram of an exemplary system for identifying launch parameters, consistent with disclosed embodiments.

FIG. 2 is a block diagram of an exemplary operating environment, consistent with disclosed embodiments.

FIGS. 3A-3C are illustrations of exemplary received images, consistent with disclosed embodiments.

FIGS. 4A-4D are illustrations of exemplary refined images, consistent with disclosed embodiments.

FIGS. 5A-5D are illustrations of exemplary output of a machine learning model, consistent with disclosed embodiments.

FIG. 6 is a flow chart of an exemplary method for identifying launch parameters, consistent with disclosed embodiments.

FIG. 7 is a flow chart of an exemplary method for training a machine learning model, consistent with disclosed embodiments.

FIG. 8 is a flow chart of another exemplary method for training a machine learning model, consistent with disclosed embodiments.

### DETAILED DESCRIPTION

Exemplary embodiments are described with reference to the accompanying drawings. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system or configuration. Additionally, some of the described embodiments or elements thereof can occur or be performed (e.g., executed) simultaneously, at the same point in time, or concurrently.

Technical problems exist in the current state of the art (e.g., utilizing currently available launch monitors) as discussed in more detail in the Background Section above. Launch monitors, as used herein, may refer to a device, system, or machine used to analyze the motion, impact, or flight characteristics of an object, e.g., in sports such as golf or baseball. Launch monitors may use sensors, cameras, radar, or optical systems to capture data (e.g., images) about the object (e.g., a golf ball or club, or a baseball or bat) during its motion. Launch monitors may also provide real-time data, making their application even more useful to those seeking to improve their skills or make equipment choices (e.g., players of a sport).

Current determinations of launch parameters may require first detecting object markers based on a plurality of received images or based on a video feed, and then determining launch parameters based on an analysis of each image (or video frame), wherein many of the images (or frames) include interfering features that lead to inconsistent analysis. An object marker, as used herein, may refer to an identifiable item placed in a space or on an object to aid in the detection and tracking of an object within that space. In contexts such as launch monitors or imaging systems, an object marker may serve as a reference point to identify and track the position, movement, or characteristics of the object to which the object marker is near or attached. Object markers may be designed to be easily distinguishable from their surroundings, e.g., using contrasting colors, patterns, or shapes to be detectable. Launch parameters may refer to various metrics (e.g., measured based on an analysis of images captured by, e.g., a launch monitor) such as ball speed, launch angle, spin rate, trajectory, or clubhead speed, for example. The accurate and consistent determination of launch parameters may be useful for, e.g., understanding performance or improving technique, and may relate directly to an ability to consistently and efficiently detect and evaluate object markers within captured images. The captured images may also include, e.g., noise, light, blurring, shadows, or glare that interferes with the detection or evaluation of the object markers. The methods, systems, and media disclosed herein address these and other technical problems by incorporating both refinement and machine learning into the object marker detection process or the launch parameter determination process based on detected object markers.

For example, some disclosed embodiments describe training the machine learning model(s) to output consistent and accurate identifications, and improving computer vision aspects with machine learning model(s) results in an improved process and system for identifying object markers or determining launch parameters based on received images. Even further, some disclosed systems, methods, and media also improve the process and system by generating refined images which may further clarify the relevant features (e.g., by eliminating or minimizing interfering features) within the received image, thereby enabling the machine learning model(s) to better detect and analyze object markers or to better identify launch parameters based on the object markers. Thus, the disclosure provides for improved and particular systems, processes, and methods for identifying object markers or determining launch parameters based on received images, and further regardless of the existence of interfering features within the images due to, e.g., environmental noise.

Interfering features, as used herein, may refer to elements also captured in the received image or conditions existing during the image capture, either of which negatively affect the clarity, accuracy, or reliability of the relevant data (e.g., object markers) captured by an imaging device. Interfering features act as noise, which refers to an image feature that may be distracting to the detection process of intended objects, such as, e.g., an object marker associated with a golf ball or with a golf club. Interfering features may include, e.g., blurriness, glare, environmental graphics or detail, reflections, irrelevant objects, motion artifacts or distortions, shadow interference, inconsistent lighting, overexposed or underexposed areas, environmental movement, ball deformation, scuff marks, grass or dirt (or turf), hand or glove markers, static interference, movement of clothing, wind or airflow disturbance, overlapping or duplicate images, irrelevant markers, vibrations or instability, imaging device setup errors, or unexpected environmental factors (e.g., insects, plants, rain, water, wind, other weather).

The methods, systems, and media disclosed herein further provide technical improvements to the fields of artificial intelligence and image processing technology. For example, embodiments consistent with the present disclosure increase the efficiency and accuracy of systems and methods (and processors) for detecting object markers amongst other interfering features captured in the image, as well as determining launch parameters based on the detected markers, based on received input images of the object(s). For instance, a machine learning model consistent with disclosed embodiments may output a visual graphic of detected and categorized object markers in response to receiving an input (e.g., a user input, or an imaging device output, or both) comprising one or more images showing the object(s) as captured in motion. As a result, a user may not be required to have any knowledge or experience with respect to detecting or categorizing image markers in order to receive information from the machine learning model (as currently required in extant processes).

Moreover, the disclosed systems and methods can improve the field of computer vision, particularly when applied to situations without controlled settings (like outdoor settings). For example, as further disclosed below the discloses systems can integrate techniques for refined image processing techniques with machine learning models. This setup of image processing improves inefficiencies and inaccuracies of current systems that, e.g., have difficulty in providing accurate and consistent image results. The disclosed systems and methods thus enable consistent and accurate identification of object markers and determination of launch parameters based on identified object markers, even in the presence of interfering features such as noise, glare, and motion artifacts. The disclosed systems and methods can thereby also improve the reliability and performance of computer vision applications in detecting and analyzing object markers or objects within received images.

Furthermore, the machine learning model outputs can improve the technical field of image evaluation with more objective and consistent results than similar information that might be provided by an individual grader of the same object or image. As an example, the same object image may cause a different output if multiple assessors (e.g., multiple individual graders) are utilized (while the opposite is true if a machine learning model consistent with disclosed embodiments is utilized instead).

Additionally, a set of rules (e.g., training data) that is input to a machine learning model will be treated much more objectively than the same set of rules, if the rules are provided to multiple assessors. By avoiding such issues, the present disclosure provides improved processes both for detecting object markers and determining launch parameters based on received images including those capturing additional interfering features.

In some embodiments, the machine learning model may also be trained using large datasets of code or natural language, which may be sourced from disparate places, enabling the model to learn to accurately detect object markers despite other image noise, and to accurately determine object parameters (e.g., launch parameters) based on the detected object markers, even if the received image quality is poor and even despite interfering features in the received image. This is particularly helpful for the process of identifying launch parameters based on detected markers because certain markers may be difficult to identify or otherwise assess given the interfering features in the image (and given a smaller amount of images provided as input) in order to determine a launch parameter (e.g., if one or more markers are difficult to view due to interfering image features, such as glare, shadow, light, or other noise, or if another type of marker—or what seems to be a marker—is visible). While current assessors and models would be incapable of processing such large datasets, the machine learning model is capable of handling such large datasets and the output generated (e.g., detected markers, identified launch parameters) is improved to be, e.g., more accurate, consistent, and objective, by training the model using such large datasets. Particularly, the large datasets may encompass details relating to the types of markers as well as the various types of interfering features, thereby enabling the machine learning model to, e.g., identify minor or blurry details, distinguish between different types of markers, or detect (and eliminate or minimize) interfering features. The present disclosure further improves machine learning model performance itself by providing methods and systems for fine-tuning trained machine learning models based on known information related to, e.g., particular object markers (e.g., types of ball markers, types of golf club markers) or particular object features (e.g., object patterns, known environmental markings, interfering features, etc.), known associations, or other data that is newly sourced or generated by the machine learning models themselves.

Practical application examples consistent with the present disclosure may include identifying object markers or determining launch parameters based on images received (e.g., images captured by a launch monitor or other imaging device) on a large scale and at a rate and accuracy previously not possible (e.g., at least because the received images were not processible to accurately or consistently identify object markers and determine launch parameters based on identified markers). Other practical application examples include generating objective and trustworthy determinations of launch parameters or detected object markers based on received images of varying quality. Overall, the present disclosure may be used to assist in the processes of testing or production, allowing for more accurate and consistent results while simultaneously minimizing the resources required for performing the testing (e.g., of a golf ball or golf equipment in production).

Reference will now be made in detail to the exemplary disclosed embodiments, examples of which are illustrated in the accompanying drawings. Illustrative embodiments consistent with the present disclosure are described below.

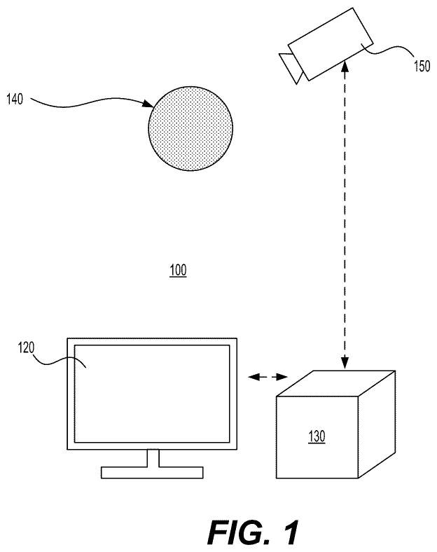

FIG. 1 illustrates an exemplary embodiment of a system 100 for identifying launch parameters associated with a captured object, according to disclosed embodiments. In some embodiments, the captured object may be a golf ball or a golf club (or both a golf ball and a golf club may be captured). In some exemplary embodiments, system 100 may include an imaging device 150, at least one memory storing instructions (not shown in FIG. 1), and at least one processor 130 configured to execute the instructions to perform operations for identifying launch parameters. It will be understood that imaging device 150 may include a wide area three-dimensional measurement system, or a two-dimensional or three-dimensional profiler system. Imaging device 150 may be part of or associated with a launch monitor. Exemplary imaging devices may include a three-dimensional optical scanner or imager, that is configured to obtain an image of an object or multiple objects in motion (e.g., object 140) and accurately capture the position of object markers placed along the surface of the object(s). Imaging device 150 may have one or more cameras having a resolution of at least 0.001 inches per pixel and 0.001 inches per unit change in brightness. Imaging device 150 may also include, e.g., high-speed cameras, optical microscopes, infrared imaging devices, x-ray imaging devices, magnetic resonance imaging (MRI) devices, phased array imaging devices, electron-based imaging devices, or other high-speed imaging, infrared thermography, or non-invasive imaging devices. Imaging device 150 may also have imaging sources in multiple frequencies and may be capable of forming composite images. For example, in some embodiments, imaging device 150 may include multi-wavelength image capturing and processing capabilities to generate composite images. Imaging device 150 may be a three-dimensional imaging device or may contain other types of cameras configured to obtain one or more digital images of the object(s). Imaging device 150 may be configured to generate high resolution images, datasets, files, or other elements associated with capturing the object(s). As further depicted in FIG. 1, system 100 may also include a display 120 (e.g., a screen, a computer display, or other interface) for providing output generated, e.g., by processor(s) 130 to a user.

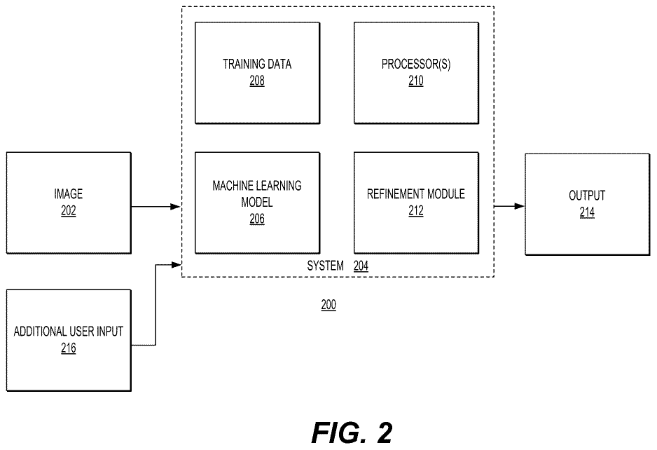

FIG. 2 illustrates an exemplary operating environment 200 for performing at least some disclosed functions (e.g., identifying or classifying object markers, or identifying launch parameters), according to disclosed embodiments. A launch parameter, as used herein, may refer to a characteristic or measurement related to an object's movement or behavior during its launch (e.g., initial movement, later movement). A launch parameter may be determined, e.g., by analyzing the data collected based on one or more identified object markers, which track, e.g., the position, velocity, spin, or other features of the object as it is launched or as it is in motion. For example, in the context of a launch monitor for golf, launch parameters may include the ball's speed, launch angle, spin rate, or direction, all of which may be derived by detecting the ball's position and motion using object markers placed on or near the ball (the same may be done for golf equipment, such as golf clubs, which may be used to strike the ball, causing the launch thereof). This information may further be utilized to analyze, e.g., the ball's flight dynamics or to provide insights into the performance of the golf ball or the dynamics of a golf swing or shot. Similarly, in other fields like robotics or motion capture, launch parameters may include measurements of initial velocity, trajectory, or the angle of an object as it moves or is launched.

As shown in FIG. 2, exemplary operating environment 200 includes system 204 which receives an image 202 and ultimately generates an output 214 based on the received image 202. Received image 202 may be a visual representation (e.g., a picture, a photograph, or another type of illustration). In other embodiments, received image 202 may be provided in another format for representing information as captured by an imaging device (e.g., imaging device 150). For example, in some embodiments, received image 202 may include a set of values (e.g., image values and coordinates provided in a spreadsheet, chart, table, or other document). A point cloud, in which a set of values within a spreadsheet may be mapped to a 3D coordinate system, is an example of such a set of values.

In some embodiments, one or more memory devices (not shown in Figures) may be associated with the system (e.g., with system 204 or with system 100). Such memory devices may store, for example, data or one or more control routines, instructions, mathematical models, algorithms, machine learning models, etc. The one or more memory devices may embody non-transitory computer-readable media, for example, Random Access Memory (RAM) devices, NOR or NAND flash memory devices, Read Only Memory (ROM) devices, CD-ROMs, hard disks, floppy drives, optical media, solid state storage media, etc.

In some embodiments, a power supply (not shown in Figures) may be configured to supply power for operation of one or more components of a system (e.g., system 204 or system 100). For example, a power supply may be configured to supply power for operation of an imaging device (e.g., imaging device 150) and connected components such as, e.g., a processor (e.g., processor 130) or a display screen (e.g., display 120). The power supply may be electrically connected to the components via one or more connectors or wires (not shown in Figures). In some embodiments, the power supply may include a battery. In other embodiments, the power supply may be connectable to an external power grid for receiving power from the external power grid. In some embodiments, multiple power supplies may be connected to the system to accommodate the needs of various devices.

In some embodiments, one or more communication lines (not shown in Figures) may transfer signals from the imaging device to a processor (and vice versa) or from the processor to a display screen. Communication lines may include, e.g., serial communication lines, universal serial bus (USB) communication lines, Ethernet communication lines, or inter-integrated circuit (I2C) communication lines. It is contemplated, however, that in some embodiments, the imaging device may be configured to transfer or receive signals wirelessly to or from the processor (or wirelessly from the processor to the display screen or another component of the system or operating environment).

With further reference to FIG. 2, system 204 may further include machine learning model 206, training data 208, processor(s) 210, and refinement module 212. System 204 may also receive additional user input 216 for further training (e.g., for fine-tuning machine learning model 206, or to provide for adjustments to output 214). Image 202 may, e.g., be an image captured by an imaging device (e.g., imaging device 150). Output 214 may include an identified object marker, launch parameter, score, grade, rating, attribute, graphical data, text or voice data, or other data associated with the received image and based on object markers detected in the received image. As an example, system 204 may output a determined launch parameter based on specific object markers detected in a particular received image of the object. In some embodiments, the launch parameters may be indicative of the quality (or an associated aspect of quality, such as, e.g., spin, power, or force) of a given object or product (e.g., a particular golf ball or a particular golf club, or a combination thereof).

As further shown in FIG. 2, refinement module 212 of system 204 may pre-process received image 202 prior to (or at least separate from) analysis of the image by machine learning model 206. For example, refinement module 212 may generate one or more refined images based on received image 202. A refined image may be generated by refinement module 212 using any of the techniques described below (or any combination thereof). Based on the refined image generation process, a refined image may contain more clarity of the object markers or less interfering features, wherein the object markers may or may not be identifiable solely from received image 202 (e.g., before refinement). The refined image generated by refinement module 212 may then be provided to machine learning model 206 for detecting object markers or determining launch parameters, and machine learning model 206 may thus be enabled to provide an accurate and objective output based on the refined image rather than based on the received image 202, which may not be as clear or indicative of the actual object markers.

Various image processing and enhancement techniques may be applied by the system (e.g., via refinement module 212, or via machine learning model 206). These techniques may, e.g., highlight particular object markers, enhance the contrast of the object markers relative to background or interfering features, or provide a more detailed view of the object markers. The following is a non-exhaustive list of methods and technologies which may be used by the system (e.g., via refinement module 212, or via machine learning model 206) to enhance the detection and differentiation of various object markers in the received image.

Increasing the resolution of the received image may reveal finer details of the object markers. Similarly, zooming in on a particular region of the image may reveal similar finer details if desired. Zooming in may be performed without losing image or resolution quality.

Adjusting the contrast of the received image may also enhance visibility. For example, subtle features may be made more or less apparent, based on the desired end result, by adjusting the contrast (either up or down) to accentuate or hide differences between areas of differing color. Continuing the example, decreased contrast of at least certain portions of the received image may assist in disregarding irrelevant image features (e.g., noise, lighting, shadow, glare, etc.) which is visible in the received image (and thus negatively affects the analysis of the image).

The received image may also be corrected or adjusted for brightness and exposure. Such correcting may include adjusting camera gain or balancing light such that the image becomes evenly lit. Another technique for correcting may include preventing shadows from existing in the image. Correcting or adjusting for brightness and exposure may result in an image having greater detail and lacking obstructive elements (including, e.g., interfering features, as described herein).

Edge detection may also be applied (e.g., via one or more edge detection algorithms). Edge detection may provide outlines of object markers, thereby making such features easily distinguishable and identifiable by the machine learning model. Edge detection may further enhance details of the object markers by enhancing the definition of all edges in the image, which would include edges of interfering features that may be identified as such and disregarded based on such identification by the machine learning model.

The received image may also be enhanced for color. For example, adjusting the color levels or using false color techniques may differentiate object markers from interfering features, particularly if the object markers are designed to be clarified via such color adjustments. As another example, color may be adjusted to remove slight variations of color in the received image. This, in turn, may help highlight the object markers more clearly, while assisting with removing particular interfering features such as, e.g., fading or discoloration.

The received image may also be processed via filtering. Filtering, as used herein, may refer to manipulating an image by applying a filter to alter its appearance or extract specific information (e.g., product damage). Filters may refer to mathematical operations or algorithms that may modify the intensity values of an image's pixels based on certain input criteria. For example, unwanted noise or distortions that may obscure object markers may be removed from the received image using a filter having a threshold associated with a certain noise level desired to be omitted. As another example, sharpening filters (e.g., filters which increase the intensity values of pixels) may be applied to the received image to make details more distinct, thereby revealing both highly evident and subtle damage.

Magnification or zoom techniques may also be applied to the received image. For example, digital magnification may be used to zoom into specific areas of interest, further enhancing the visibility object markers. As another example, combining multiple views of different angles of object markers may enable the machine learning model to have a more comprehensive perspective on the object markers (as well as the determined launch parameters based on detected object markers). For example, the machine learning model may be enabled to create a 3D model of the object to visualize parameters of that object from a variety of different angles. Furthermore, based on the generated 3D model, the machine learning model may measure features within the 3D model itself to identify launch parameters based on detected object markers (or to identify other parameters based on the detected object markers).

The refined image may further be associated with data (e.g., metadata) regarding the object(s) in the received image (e.g., the number or arrangement of dimples (e.g., a dimple pattern) on the object's surface, or other data associated with a particular golf ball, golf club, or other object in the received image), and such information may be utilized during analyzing by the machine learning model. As interfering features associated with the object or the environment surrounding the object are minimized (e.g., the dimple pattern or other object-associated data), the refined image may provide clarification of the object markers through minimization of the interfering features (based on the knowledge provided by the associated data).

Interfering features, however minor, may be minimized or eliminated entirely as well in the refined images. For example, background imperfections may become less visible in the image. As another example, anomalies in surrounding areas, such as seams or uneven areas associated with the object(s), may be made more or less visible in the image in order to allow for distinction via, e.g., edge detection techniques.

As a result of the further clarity provided via the refined images, various specific types of object markers may become identifiable more readily (e.g., by a machine learning model trained to detect object markers or to identify launch parameters based on detected object markers). For example, the following non-exhaustive types of object markers may be identified from the refined image(s):

Ball-based markers. Ball-based markers may include object markers placed on a ball (e.g., circular ball markers, ball center markers) which may aid in tracking the motion and behavior of the ball. Such markers may include, e.g., spin-specific markers (e.g., markers designed to track spin rate, spin axis, and rotation, such as striped markers or markers placed at opposite points to highlight the spin axis), trajectory markers (e.g., markers positioned on the balls surface in a given pattern, such as a circle, to detect flight path or launch angle), and impact markers (e.g., markers particularly aligned to detect deformation or initial acceleration of the ball). Ball-based markers may comprise various shapes (e.g., circular, oval, square, triangular) and may be aligned in various patterns or at particular locations along the ball's surface (e.g., center, midline, opposite ends) for easy identification.

Club-based marker(s). Club-based markers may include object markers placed on a golf club (e.g., club hosel markers, club toe markers) and may aid in assessing swing mechanics or impact dynamics. Club-based markers may include club hosel (e.g., where the shaft connects to the club head) markers, club toe (e.g., outermost part of golf club head) markers, other club head markers (e.g., face, sole, heel, crown, back, leading edge, trailing edge, loft, or bulge and roll), shaft markers, or the point of contact between a club and a ball.

Accordingly, by improving the received image and providing an improved image (e.g., refined image) to a machine learning model, the machine learning model is enabled to generate an improved output (e.g., output 214) based on the improved image and the clarified object markers (and thereby the position and launch parameters of the object as it moves). It will be understood that such output may be generated continuously for a stream of images of objects having varying positions and trajectories.

With further reference to FIG. 2, exemplary system 204 may further include training data 208, and machine learning model 206 may be trained using training data 208. Training data, as used herein, may refer to the initial dataset used to train a machine learning model. Such an initial dataset may include, e.g., input-output pairs, where the inputs are the features from which the model learns, and the outputs are the correct or expected responses (e.g., labels or targets). The model may use this initial dataset to identify patterns, learn correlations, and build its understanding of the problem it is being trained to solve (e.g., providing a grade based on an image). Machine learning model 206 may also further be trained based on fine-tuning data. The model may, e.g., adjust its parameters (e.g., weights) to minimize error in its predictions based on fine-tuning data. Fine-tuning data, as used herein, may refer to additional datasets or information used for further training a machine learning model. Fine-tuning may refer to a process of adjusting a model already trained on a larger, more general dataset (e.g., an initial dataset) to better suit the specific task or domain of grading products based on damage. In this case, the fine-tuning data may include smaller, domain-specific datasets (e.g., datasets that account for specific types of objects or object markers, or specific types of interfering features expected to be found or identified in certain environments), which allow the model to adapt and further improve its performance in grading or otherwise assessing the objects (via images thereof) based on the detected object markers.

In some embodiments, system 204 may be configured to perform operations. In some embodiments, the operations may include receiving an image (e.g., image 202) of an object captured by an imaging device (e.g., imaging device 150 of FIG. 1).

In some embodiments, the imaging device (e.g., imaging device 150) may include an adjustable aperture lens or a color sensor (or a calibrated measurement tool (e.g., a color calibrator or photogrammetric calibrator)). An adjustable aperture lens, as used herein, may refer to a type of camera lens that allows for changing the size of the aperture opening, either manually (e.g., via a physical ring on the lens or camera controls) or automatically (e.g., via automatic adjustment based on exposure settings or program modes). The aperture opening refers to the opening in a lens through which light passes to enter the camera of an imaging device. Adjusting the aperture opening size may control the amount of light that reaches the camera (or a sensor thereof) and influences other aspects of a captured image, such as the depth of field and the sharpness. Hence, an adjustable aperture lens may improve the imaging device by enabling control over light exposure, depth of field, image sharpness, and motion blur. Such flexibility may improve the quality, versatility, and functionality of the imaging device. A color sensor, as used herein, may refer to a device that detects and measures color by capturing the wavelengths of light reflected from objects. A color sensor may include photodetectors, color filters, analog to digital converters, light sources, or microcontrollers. A color sensor may improve the imaging device by, e.g., enhancing its ability to accurately capture, reproduce, and process colors and producing more precise and true-to-life color representation in images that are captured by the imaging device. The imaging device may also include an onboard graphics processing unit (GPU, e.g., a graphics processor that is built directly into the motherboard or CPU of a device rather than being a separate, dedicated graphics card) or an AI chip (e.g., a specialized hardware component engineered to perform complex computations for AI workloads, such as deep learning, neural networks, and inference processing, which often require large amounts of parallel computing power).

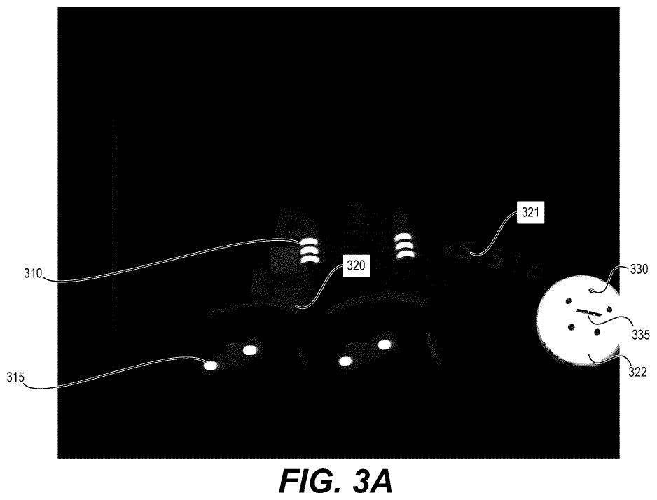

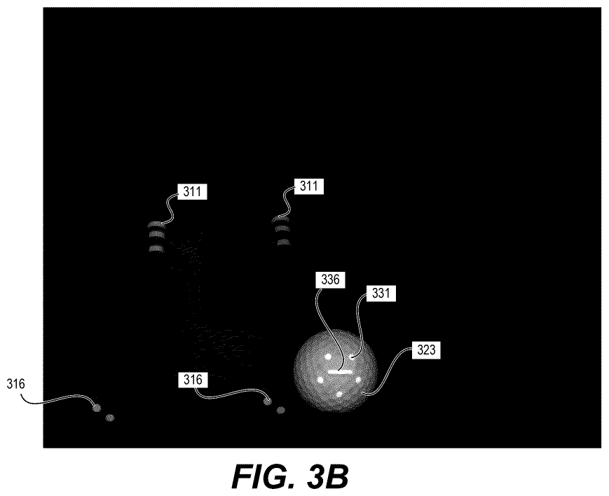

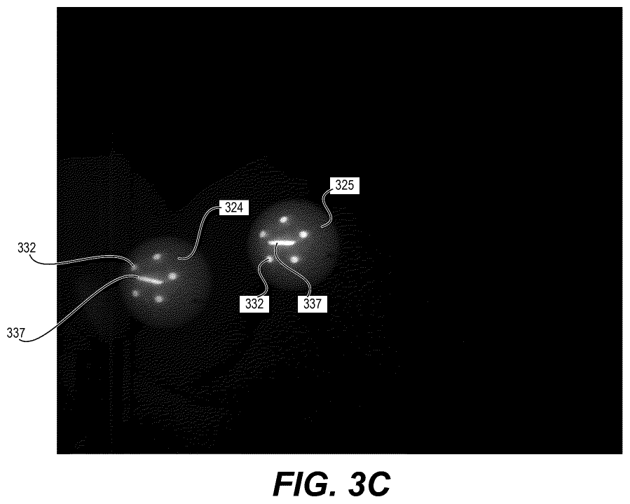

FIGS. 3A-3C illustrate exemplary images captured by an imaging device (e.g., by imaging device 150), according to disclosed embodiments. The imaging device may be configured to obtain or capture an image, such as the example shown in any one of FIGS. 3A, 3B, or 3C. FIGS. 3A-3C show various examples of an input image containing objects and object markers, as well as interfering features. It will be understood that fully colored height images of the objects may also be generated by the imaging device. The images of the objects may also be three-dimensional, and the imaging device may use associated software or electronic equipment to allow a user to view the object as a model or the image(s) at various angles, prior to completion of the image that is eventually input to the system. The imaging device may comprise, e.g., a wide area three-dimensional measurement system, or a two-dimensional or three-dimensional profiler system. Exemplary equipment for performing the capturing of the image may include a launch monitor. Exemplary equipment for performing the capturing of the image may also include a three-dimensional optical scanner or imager (or imaging device), that is configured to obtain an image of one or more objects in motion. The imaging device may, e.g., have a resolution of at least 0.001 inches per pixel and 0.001 inches per unit change in brightness. The imaging device may be a three-dimensional imager. The imaging device may be configured to generate high resolution images, datasets, files, or other elements associated with imaging or scanning of the object(s).

The exemplary received image of FIG. 3A shows a captured image of a golf club and a golf ball, which includes object markers 310, 315, 330, and 335. Object marker 310 is a club shaft marker, object marker 315 is a club toe marker, object marker 330 is a circular ball marker, and object marker 335 is a ball center marker. FIG. 3A further includes interfering features 320, 321, and 322. Interfering feature 320 is a reflection of the golf club (which can also be seen in other portions of the image). Interfering feature 321 is an environmental graphic that also is reflected in the captured image. Interfering feature 322 is a reflection of the golf ball, which appears white in the image and may create confusion during analysis (since, e.g., the object markers may be expected to appear as white). FIG. 3A further includes object markers 330 and 335, which appear as black (e.g., instead of an expected white appearance), which may further confuse analysis.

The exemplary received image of FIG. 3B shows another captured image of a golf club and a golf ball, which includes object markers 311, 316, 331, and 336. Object marker 311 is a club shaft marker, object marker 316 is a club toe marker, object marker 331 is a circular ball marker, and object marker 336 is a ball center marker. FIG. 3A further includes interfering feature 323, which is a reflection of the golf ball, appearing in white and also including the dimple pattern of the golf ball, any one of which may confuse analysis.

The exemplary received image of FIG. 3C shows yet another captured image of a golf ball. FIG. 3C further includes object markers 332 and 337. Object marker 332 is a circular ball marker, and object marker 337 is a ball center marker. FIG. 3C further includes interfering features 324 and 325, each of which is a reflection of the golf ball, appearing in greyscale and limiting the contrast of the object markers located on the golf ball (which appear in white), any or all of which may confuse analysis. FIG. 3C also includes a glare (not labelled), which may require adjustment of camera settings such as, e.g., gain (and thus further may confuse analysis).

In some embodiments, the operations (performed, e.g., by system 204) may further include generating a refined image based on the received image (e.g., image 202). The generating of a refined image may be performed, e.g., by refinement module 212. A refined image, as used herein, may refer to a modified version of an original image (e.g., the received image) in which unwanted or interfering features (such as blurriness, glare, irrelevant objects, reflections, shadows, or other types of environmental noise) have been minimized, corrected, or removed to enhance the overall clarity, focus, or quality of the image (and thus enhancing the detectability of relevant object markers). Example refined images may include images with increased resolution, images with glare or reflections minimized or removed, images of enlarged portions of the object or markers with surrounding environmental elements minimized or removed, annotated images or annotated portions of the object or markers, and other processed or reformatted images that more clearly delineate or indicate object markers while minimizing interfering features. Thus, the refined image may, e.g., correct one or more interfering features associated with the received image. Correcting, as used herein, may refer to resolving specific interfering features (e.g., modifying, mitigating, eliminating one or more interfering features) within an image to produce a more accurate and usable result, thereby addressing issues in the received image that distort or obscure relevant elements (e.g., object markers) in the image. For example, correcting may involve enhancing visual details (e.g., by sharpening blurry regions or restoring lost resolution), balancing light (e.g., adjusting brightness, contrast, or exposure to, e.g., minimize overexposed or underexposed areas), removing obstructions (e.g., eliminating irrelevant objects, reflections, or environmental noise that may detract from the relevant elements, refining edges or textures (e.g., smoothing motion artifacts or cleaning up distorted features), or neutralizing distractions (e.g., suppressing shadows, glare, or patterns that may interfere with detection or analysis based on the detection).

In some embodiments, generating the refined image may also include at least one of modifying a contrast, color, hue, or sharpness of the received image, or otherwise reformatting the received image. Reformatting, as used herein, may refer to any one of rotating, shifting, scaling, flipping, cropping, zooming, altering shape, color jittering (e.g., applying random variations to the colors of an image), normalizing pixels, standardizing pixels, performing color conversion, masking out (e.g., selectively excluding or modifying specific parts of an image), or otherwise augmenting or processing an image or a portion thereof.

In some embodiments, generating the refined image may further include decomposing the received image into spatial components and frequency components. Spatial decomposition may involve breaking an image into its constituent regions or pixel-based details, as they appear in space (e.g., in the original layout of the received image). For example, the received image may be decomposed to be represented as a grid of pixel intensities (e.g., brightness or color values). Spatial decomposition may also aid in dividing an image into areas with shared characteristics, such as edges, textures, or regions of uniform intensity. Decomposing, as used herein, may refer to performing image segmentation (e.g., dividing the image into regions) or applying filters (e.g., edge detection algorithms) to isolate specific features. Frequency decomposition may involve analyzing an image based on the variations in intensity over distance, represented as different frequency components. Low-frequency components may correspond to slow changes, such as smooth gradients or large regions of similar color. High-frequency components may correspond to rapid changes, such as edges, fine details, or noise. It will be understood that spatial data may also be converted into frequency data, using, e.g., a Fourier transform or a Wavelet transform. It will be further understood that decomposing the received image into such components enables further insights based on the structure of the received image as well as the targeting of specific features (e.g., removing noise, enhancing object markers, or smoothing regions) for refinement or analysis.

In some embodiments, generating the refined image may include recovering a marker feature degraded by at least one of the interfering features associated with the received image. Recovering a marker feature, as used herein, may refer to restoring or enhancing a degraded marker feature so it may become more clear or processible for its intended purpose. For example, recovering may include removing noise, restoring sharpness, or adjusting lighting, contrast, or gain. A degraded marker feature, as used herein, may refer to an object marker that is at least partially obscured (e.g., by one or more interfering features). As an example, if the image shows a golf ball with a marker but the marker is partially obscured by a glare, recovering the marker feature may involve removing or minimizing the glare to recover the full visibility of the marker. As another example, if a club's hosel marker is blurred due to motion, recovering the marker feature may include applying deblurring techniques to restore the sharpness of the marker. As yet another example, if environmental noise (e.g., debris) obscures the marker, recovering the marker feature may involve cleaning at least part of the image to, e.g., isolate or highlight the marker.

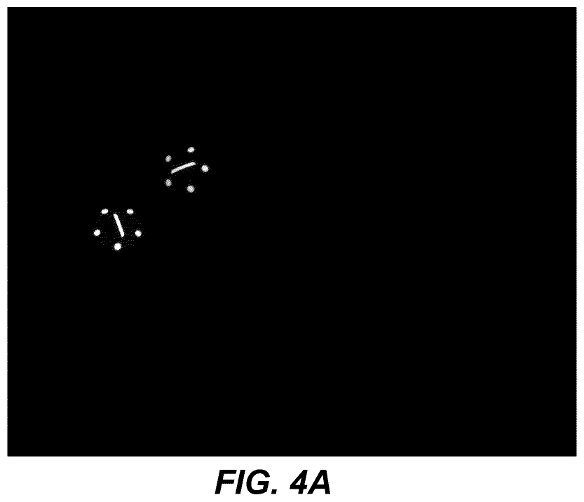

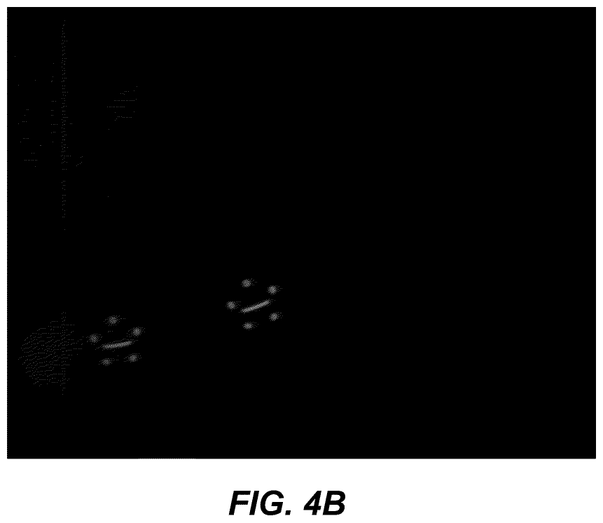

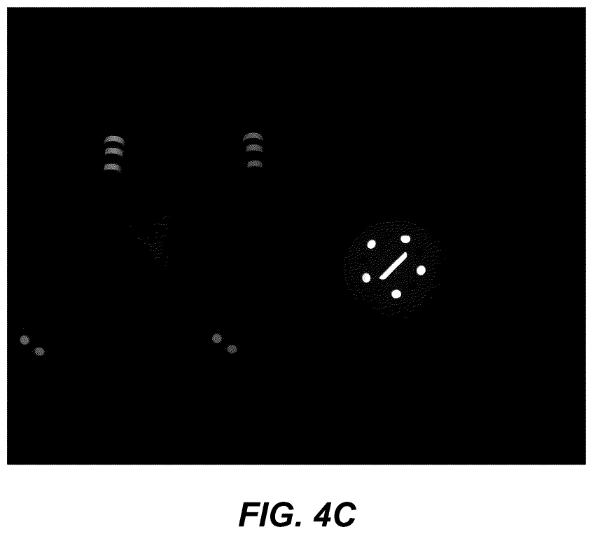

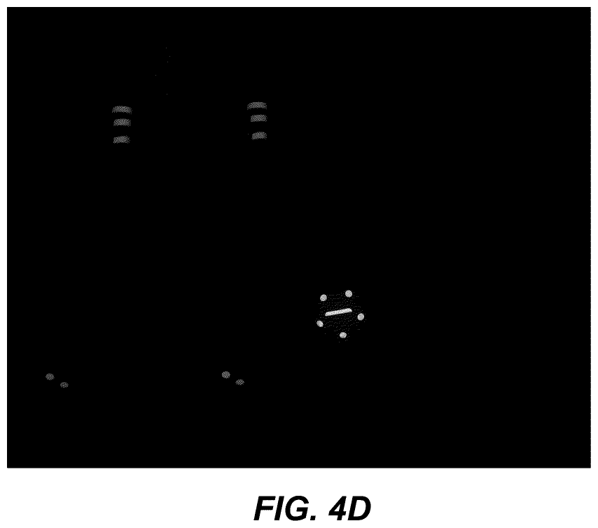

FIGS. 4A-4D illustrate exemplary refined images, any of which may be generated by a system (e.g., system 204, or refinement module 212), according to disclosed embodiments. Each of these figures is described in more detail below.

FIGS. 4A-4D illustrates exemplary refined images that may be generated from a received image, such that interfering features associated with, e.g., environmental or background conditions may be mitigated, filtered out, or eliminated, while other relevant features (e.g., features associated with the object markers) may remain or be highlighted. It will be understood that additional image processing functions could be applied further to these refined images or any other images of the object (albeit such further processing is not needed for the machine learning model to accurately analyze the image). As shown in FIGS. 4A-4D, object markers are identifiable via the white-colored areas on the otherwise near-black image of the object. FIG. 4A shows a refined image that is near maximum clarity (e.g., near complete elimination of interfering features, albeit such complete elimination may not be required). FIGS. 4B-4D show example refined images that are less clear (e.g., some interfering features are still visible), but these examples demonstrate that some interfering features from the originally received image may remain in the refined image. It will thus be understood that the refined image may retain some interfering features and may be of varying clarity while still being processible by the machine learning model to correctly and consistently analyze the refined image to recognize object markers and determine launch parameters based on the recognized markers.

FIGS. 4A-4D thereby illustrate examples of refined images that lead to an improved (e.g., faster and more accurate) analysis of launch parameters (e.g., based on the refining of the received image to clarify object markers and to minimize interfering features).

In some embodiments, the operations (performed, e.g., by system 204) may further include analyzing the refined image using a machine learning model (e.g., machine learning model 206), the machine learning model being trained, using a plurality of object images (or other data), to recognize object markers in images received as input. In some embodiments, the machine learning model may further be trained, using a plurality of object images (or other data), to identify one or more launch parameters based on the recognized object markers. Analyzing, as used herein, may refer to inspecting a refined image (or another received image) to detect one or more object markers or to determine launch parameters based on the detected object marker(s). A plurality of object images (for training the machine learning model) may refer to a diverse set of images used to train the machine learning model, and may include object marker variations (e.g., images of objects (e.g., golf balls or clubs) with different types of object markers, such as, e.g., painted patterns, reflective stickers or decals, or engraved or embossed features), object types (e.g., images of different types of objects used in the system, such as, e.g., golf balls with varying brands, sizes, textures, and marker types, golf club parts like the toe, hosel, and shaft, or accessories or tools relevant to the setup), environmental variations (e.g., images captured under different environmental conditions to ensure robustness, such as, e.g., indoor and outdoor settings, different weather conditions (e.g., sunny, cloudy, rainy, windy), or varying backgrounds (e.g., turf, sand, walls), lighting conditions (e.g., images with varying levels of lighting, such as, e.g., high glare or reflections, shadows or uneven illumination, or dim or overexposed conditions), motion or blur scenarios (e.g., images showing objects in motion or with motion blur to simulate real-world conditions), perspective or angles (e.g., images of objects captured from various angles, distances, or perspectives), object states (e.g., images of objects in different states or conditions, such as, e.g., worn or damaged surfaces (e.g., scuffed golf balls), or clean surfaces (e.g., new or pristine golf balls), noise or interference (e.g., images including potential interfering features), or special cases (e.g., images with complex or ambiguous markers to train the model on challenging scenarios, or simulated images with artificially added distortions or other interfering features for robustness or testing). By including a broad range of object images as training data, the machine learning model may generalize effectively to recognize markers and infer launch parameters across diverse real-world scenarios (e.g., with multiple interfering features within the received image(s)) and with minimal input (e.g., with only a few input images of the object(s) being analyzed).

In some embodiments, the operations (performed, e.g., by system 204) may further include training the machine learning model. In some embodiments, training may include obtaining a plurality of training images (e.g., a plurality of object images, as described herein) including one or more objects having varying speeds or trajectories (e.g., images of one or more golf balls or golf clubs in motion). Each training image may include one or more training object markers. A training object marker, as used herein, may refer to an object marker used for providing training data to the machine learning model. Training may further include inputting the plurality of training images to a machine learning model (e.g., machine learning model 206) as training data, and training the machine learning model, based on the plurality of training images, to recognize object markers in a received image and to determine one or more launch parameters based on the recognized object markers. Training the machine learning model to recognize object markers in a received image may include, e.g., providing the model with a plurality of training images (e.g., images containing labeled markers, or annotations to specify where markers are located or what they represent), performing feature extraction using the model (e.g., the model may identify unique visual characteristics that define the markers and store these representations), performing associations using the model (e.g., the model may associated the extracted features with specific categories of markers), and learning variations using the model (e.g., the model may be exposed to diverse scenarios to generalize its ability to recognize markers in varying conditions (including sub-optimal conditions). Training the machine learning model to determine one or more launch parameters may include, e.g., providing the model with a plurality of training images (e.g., images being associated with corresponding launch parameters derives from, e.g., real-world measurements or simulations), mapping relationships using the model (e.g., the model may learn relationships between the position and orientation of markers in the training images and the corresponding launch parameters associated with each training image; for example, the displacement of a marker in sequential images of the object may indicate a velocity, or the distortion of a circular marker may indicate a spin or an angle), performing regression or prediction using the model (e.g., the model may use regression techniques to predict continuous values (e.g., speed, spin rate) or classification methods to categorize parameters (e.g., launch angle categories, such as high, medium, and low), and using the model to learn complex patterns (e.g., the model may analyze variations across images to identify subtle cues, such as marker deformation or trajectory paths, that may correlate with one or more specific launch parameters). Based on the training provided to the model, the model may be enabled to process a received image, identify object markers within it, and use the identified markers to determine accurate launch parameters. Furthermore, the model may perform these tasks even in challenging conditions (e.g., glare, motion blur) due at least in part to the diverse training data provided. These training processes equip the machine learning model to, e.g., automate marker recognition and launch parameter assessment with high precision and reliability.

Training the machine learning model may also refer to adding, removing, or modifying a model parameter. Training of a machine learning model may be supervised, semi-supervised, or unsupervised. In some embodiments, training of a machine learning model may include multiple epochs, or passes of data (e.g., training data 208) through a machine learning model process (e.g., a training process). In some embodiments, different epochs may have different degrees of supervision (e.g., supervised, semi-supervised, or unsupervised). Training data may also include data previously output from a model (e.g., forming recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters or models, which may be dependent or interdependent, hierarchical, or static or dynamic. The combination and configuration of the model parameters and relationships between model parameters discussed herein are cognitively infeasible for the human mind to maintain or use. Without limiting the disclosed embodiments in any way, a machine learning model may include millions, trillions, or even billions of model parameters. A machine learning model may be or may include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or another type of artificial intelligence model.

In some embodiments, the machine learning model may be further trained to determine a type of the recognized object marker, and the operations may further comprise outputting the one or more launch parameters and the type of the recognized object marker. A type of the recognized object marker, as used herein, may refer to a specific category or label of a corresponding object marker (e.g., a trajectory marker, a spin marker, a ball-based marker, a club-based marker, or a specific type of ball-based marker or club-based marker, as described herein). The determined type of marker may be used to, e.g., further contextualize the corresponding launch parameters, assist with multiple marker analysis and interpreting each marker properly, or verify accuracy by, e.g., validating the determined type of marker. As an example, a golf ball captured in an image may include multiple markers (e.g., one or more reflective dots for spin tracking and a painted line for trajectory tracking), and the machine learning model may recognize the reflective dot(s) as spin markers. Continuing the example, the machine learning model may then use the marker type recognition to calculate a spin rate based on the detected markers and output both the spin rate and the type of marker detected (e.g., spin rate=3,000 RPM; marker type: spin marker).

In some embodiments, the one or more launch parameters may be associated with a collision between two objects (e.g., the object and another object). A collision, as used herein, may refer to an event in which two or more objects come into contact with each other. A collision may involve a significant exchange of force or energy over a short period of time, and as a result, complex interactions may occur over that short period of time. The interaction during a collision may also result in changes to the motion, shape, or energy of the objects involved. Images captured during this time period by an imaging device may thus provide valuable and instantaneous information, based on the object markers captured in the images, about the complex interactions occurring during this time period. As examples, the collision may involve a golf club (e.g., a clubface) striking a golf ball, a golf club striking the ground, a golf ball hitting another golf ball or another surface (e.g., ground, wall, sand, tree, water, or another environmental or man-made object), or a combination thereof. Images capturing the objects at the time of collision and for at least a short period thereafter (e.g., 1-3 seconds after collision) may be provided, as described herein, to accurately and efficiently detect object markers or launch parameters during these time periods.

In some embodiments, the one or more launch parameters may include at least one of a trajectory of the object (e.g., ball trajectory, including apex height and carry distance, or club path), a speed of the object (e.g., initial ball or club speed immediately after the collision, clubhead speed), a spin of the object (e.g., spin axis, or spin rate, including backspin, sidespin, or topspin), or an angle between two objects in the received image (e.g., the angle between a ball trajectory and a clubface; the orientation of the clubface at impact relative to a target line, such as open, closed, or square; or the angle at which a clubhead approaches a ball, relative to the ground). The launch parameters may also include a launch angle of the object (e.g., the angle of the object's trajectory relative to the ground immediately after collision), an impact location (e.g., the point on a clubface where a golf ball makes contact, such as the center, toe, or heel), an object impact force (e.g., an amount of force exerted on the object during collision), or a degree of deformation of the object (e.g., a degree of compression of a ball at collision). The systems, methods, and media described herein thereby enable the provision of a comprehensive analysis of colliding objects through various launch parameters determined based on even a small set of input images of the collision or of a period shortly thereafter.

In some embodiments, analyzing the refined image may comprise identifying a first object marker on a first object. For example, the first object marker identified may be a marker on a golf ball, such as a circular ball marker or a centerline marker. In some embodiments, analyzing the refined image may further comprise identifying a second object marker on the first object or on a second object. For example, the second object marker identified may be another marker on the golf ball, or a marker on a different object, such as a golf club. In some embodiments, identifying the one or more launch parameters may be based on the first object marker and the second object marker. For example, the system may utilize the position, orientation, or motion of the first object marker relative to the second object marker in order to derive launch parameters. In some embodiments, an identified golf club marker (e.g., clubhead marker) and an identified ball marker may be compared or otherwise assessed together to determine impact conditions such as, e.g., collision angle or energy transfer). In some embodiments, two ball markers (located on the same ball), or the orientation thereof, may be compared or otherwise assessed together to analyze spin rate or axis by tracking rotational motion. The first and second identified object markers may thereby provide data about various launch parameters during and shortly after the collision (e.g., the first marker may provide information about initial velocity of a ball, and the second marker may help determine rotational properties or deformation parameters of the ball; or a first ball marker may indicate the ball's trajectory or spin, a second club marker may indicate a swing path or impact point, and combining the two markers may aid in calculating launch angle, spin rate, or energy transfer efficiency).

In some embodiments, the operations may further comprise annotating the received image or the refined image to indicate at least one of a ball marker or a club marker in the received image, or a particular launch parameter associated with identified positions of the ball marker(s) or the club marker(s). In some embodiments, the operations may further comprise inputting the annotated image to the machine learning model as training data. Annotating, as used herein, may involve adding visual or metadata elements to an image to highlight the positions of object markers or derivable launch parameter data, such as, e.g., ball velocity, spin rate, launch angle, or clubhead speed. For example, the system may identify and mark a ball's position, track its trajectory or spin axis, or identify where the club strikes the ball, including impact details like attack angle or swing path. One purpose of annotating the image may be to provide visual feedback for users, ensuring that the locations of object markers and the corresponding launch parameters are clearly understood. Additionally, annotating may also help verify the accuracy of marker detection and the calculation of launch parameters, which is useful for training and testing machine learning models to improve their accuracy. Annotated images may also enable enhanced analysis by making it easier to interpret the dynamics of motion or interaction, by, e.g., offering a clearer representation of how markers influence performance or mechanical behavior. As another example, one or more image annotation tools may be utilized to draw bounding boxes, polygons, segmentation masks, or other informative symbols to highlight damage areas of the product, and these annotations may be exported as training data to be fed to a machine learning model using one or more frameworks or object detection models.

In some embodiments, the annotated image may include the ball marker indication and the particular launch parameter indication. The annotated image may thus include both a visual indication of the ball marker and the corresponding launch parameter derived from it. Therefore, the annotated image may highlight the position of the marker on the ball (such as a spot or identifier placed on the ball for tracking purposes), as well as the specific launch parameter associated with that marker (or set of markers). For example, the system may highlight a ball marker on the golf ball and annotate the image with additional information like the ball's launch speed, spin rate, or launch angle. This may allow for a clearer, more informative visual representation of how the ball's movement and characteristics are related to the identified marker, helping a machine learning model understand the relationship between the marker's position and the derived parameters. The combined annotation may help provide a complete picture of the ball's behavior during its flight, aiding analysis, training, and performance assessment.

In some embodiments, the annotated image may further indicate an association between the ball marker and the particular launch parameter. The annotated image may therefore display the ball marker and the corresponding launch parameter as well as the relationship or connection between them. The system may thus highlight how the ball marker's position or characteristics directly relate to the specific launch parameter. For example, the annotated image may visually link one or more markers on the ball to the launch angle, speed, or spin rate by drawing connections or using labels that demonstrate how the position or motion of the object marker(s) influences the calculated launch parameter. This association may assist the machine learning model to understand how the marker's location or movement contributes to the ball's overall behavior, offering a more intuitive and informative analysis of the collision dynamics.

In some embodiments, the operations may further include inputting fine-tuning data (e.g., user input data 216) to a machine learning model (e.g., machine learning model 206), and further training the machine learning model using the fine-tuning data, wherein the fine-tuning data indicates an association between received training data (e.g., training data 208) and one or more identifiable interfering features within the received training data (e.g., at least one of a type of material (e.g., golf ball surface material) or a pattern (e.g., a golf ball pattern, an environmental pattern or logo) associated with the object or with the environment in which the training image was captured. Fine-tuning data may thus be used to further train a machine learning model by associating specific interfering features in the received training data with the objects or environments captured in the images. Fine-tuning data may provide additional insights into how features like the surface material of an object, patterns such as logos or dimples, or environmental elements might influence the accuracy of marker identification and launch parameter calculation. For example, the fine-tuning data may highlight how a shiny logo on a ball or a reflective surface in the environment may create glare, which the model may then learn to correct. By incorporating the fine-tuning data, the machine learning model may further improve at distinguishing object markers from interfering features or at recognizing markers and calculating launch parameters accurately, despite challenging visual conditions. This fine-tuning process may help ensure the model accounts for real-world complexities, further enhancing the model's robustness and performance.

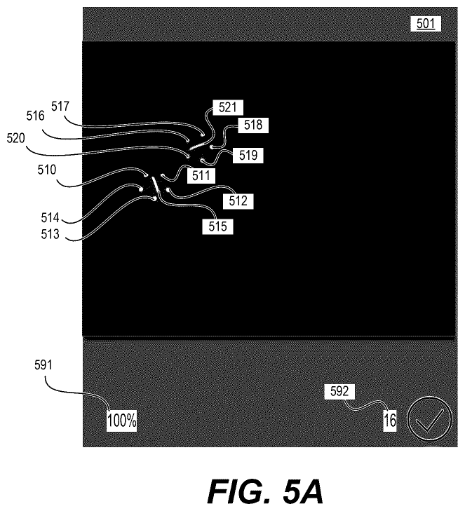

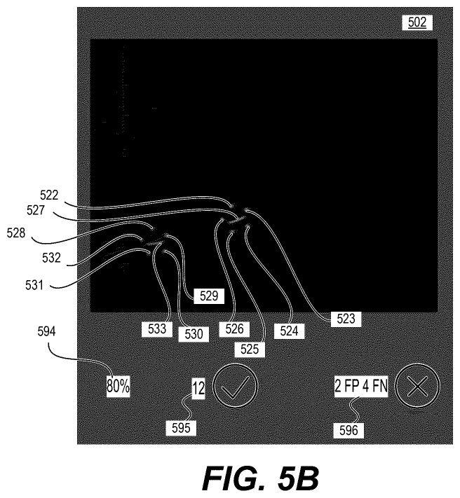

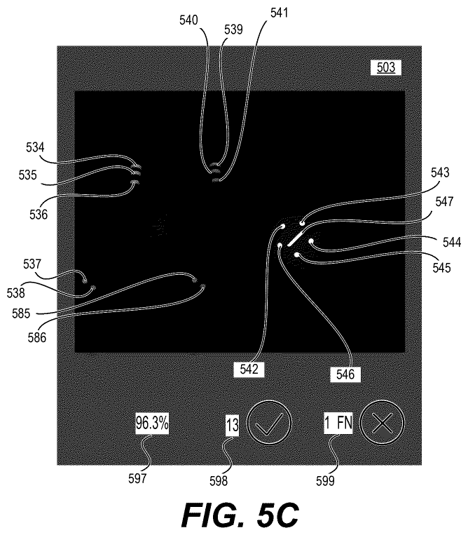

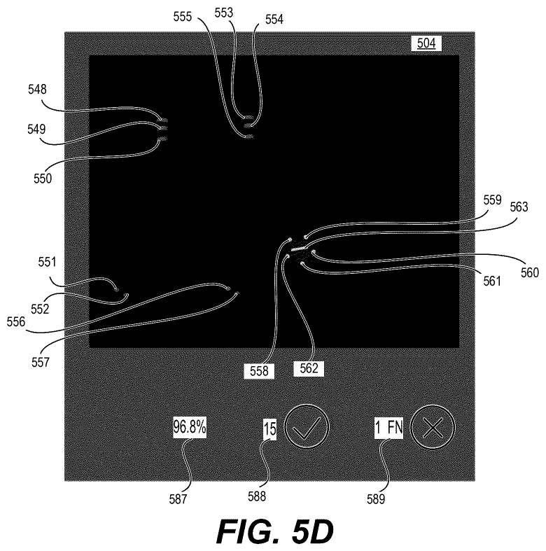

FIGS. 5A-5D illustrate example outputs of the machine learning model showing various marked locations of detected object markers in received images. FIGS. 5A-5D illustrate exemplary outputs of the machine learning model, showing refined images that are marked to indicate the locations and types of detected object markers. FIG. 5A illustrates an exemplary graphical user interface (GUI) 501 labelling the refined image of FIG. 4A to indicate circular object markers 510-514, 516-520 and linear object markers 515, 521 as located on a golf ball. It will be understood that the two sets of object markers indicate a change in the spin and trajectory of the same golf ball. FIG. 5A also illustrates a displayed score 591 that may be output by the machine learning model. The score 591 may be indicative of a confidence level associated with the model's output. FIG. 5A further illustrates a displayed value 592 indicative of an amount of iterations performed by the machine learning model based on the image shown that received a passing grade.

FIG. 5B illustrates an exemplary graphical user interface (GUI) 502 labelling the refined image of FIG. 4B to indicate circular object markers 528-532, 522-526 and linear object markers 527, 533 as located on a golf ball. It will be understood that the two sets of object markers indicate a change in the spin and trajectory of the same golf ball. FIG. 5B also illustrates a displayed score 594 that may be output by the machine learning model. The score 594 may be indicative of a confidence level associated with the model's output. FIG. 5B further illustrates displayed values 595, 596 indicative of an amount of iterations performed by the machine learning model based on the image shown that received a passing grade (e.g., 12 iterations) and an amount of iterations performed by the machine learning model based on the image shown that received a failing grade (e.g., 2 false positives FP, 4 false negatives FN).

FIG. 5C illustrates an exemplary graphical user interface (GUI) 503 labelling the refined image of FIG. 4C to indicate club shaft markers 534-536, 539-541, club toe markers 537, 538, 585, 586, circular object markers 542-546, and linear object marker 547, as located on either a golf club or a golf ball. It will be understood that the two sets of club shaft and club toe markers indicate a movement and angle of the same golf club, and that the set of ball markers indicates a movement of the golf ball as a result of being struck by the golf club shown. FIG. 5C also illustrates a displayed score 597 that may be output by the machine learning model. The score 597 may be indicative of a confidence level associated with the model's output. FIG. 5C further illustrates displayed values 598, 599 indicative of an amount of iterations performed by the machine learning model based on the image shown that received a passing grade (e.g., 13 iterations) and an amount of iterations performed by the machine learning model based on the image shown that received a failing grade (e.g., 1 false negative FN).

FIG. 5D illustrates an exemplary graphical user interface (GUI) 504 labelling the refined image of FIG. 4D to indicate club shaft markers 548-550, 553-555, club toe markers 551, 552, 556, 557, circular object markers 558-562, and linear object marker 563, as located on either a golf club or a golf ball. It will be understood that the two sets of club shaft and club toe markers indicate a movement and angle of the same golf club, and that the set of ball markers indicates a movement of the golf ball as a result of being struck by the golf club shown. FIG. 5D also illustrates a displayed score 587 that may be output by the machine learning model. The score 587 may be indicative of a confidence level associated with the model's output. FIG. 5D further illustrates displayed values 588, 589 indicative of an amount of iterations performed by the machine learning model based on the image shown that received a passing grade (e.g., 15 iterations) and an amount of iterations performed by the machine learning model based on the image shown that received a failing grade (e.g., 1 false negative FN).

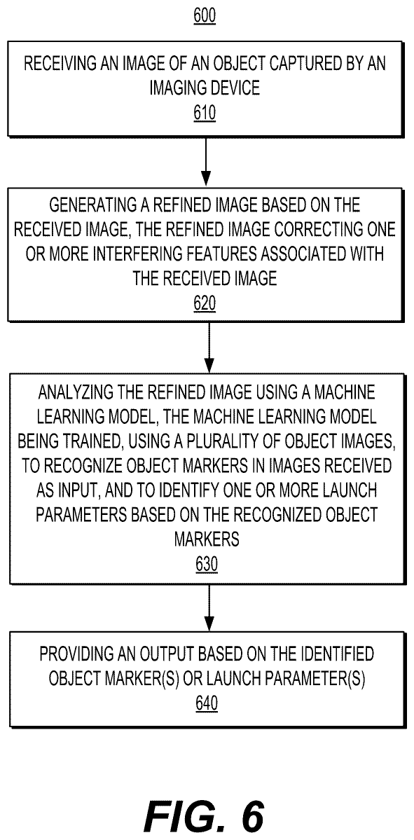

Also disclosed herein are methods for identifying launch parameters, as discussed below with reference to FIGS. 6-8.

The processes shown in FIGS. 6-8 or any of the constituent steps shown therein may be implemented using operating environment 200, system 204 (e.g., using at least one processor and at least one memory component), or any component thereof. The steps illustrated in FIGS. 6-8 are exemplary and steps may be added, merged, divided, duplicated, repeated (e.g., as part of a machine learning process), modified, performed sequentially, performed in parallel, or deleted in some embodiments.

An exemplary method 600 for identifying launch parameters, consistent with disclosed embodiments, is illustrated in FIG. 6. As illustrated in FIG. 6, exemplary method 600 may include a step 610 of receiving an image of an object captured by an imaging device (as described herein). For example, in step 610 system 204 may receive an image in a format that is usable for a machine-learning operation. For example, the image received in step 610 may be in a JPEG format. In some embodiments the image may have been captured by an imaging device associated with a launch monitor. In some embodiments, the images may be received from a remote image device, and in other embodiments, the imaging device may be directly connected to the system (e.g., system 204).

As further illustrated in FIG. 6, method 600 may include a step 620 of generating a refined image based on the received image, the refined image correcting one or more interfering features associated with the received image (as described herein). Example refined images may include images with increased resolution, images with glare or reflections minimized or removed, images of enlarged portions of the object or markers with surrounding environmental elements minimized or removed, annotated images or annotated portions of the object or markers, and other processed or reformatted images that more clearly delineate or indicate object markers while minimizing interfering features. Thus, the refined image may, e.g., correct one or more interfering features associated with the received image. As one non-limiting example, a received image may include blurred object markers and interfering background graphics, and generating a refined image may include increasing the resolution of the blurred object markers and correcting (e.g., removing) one or more of the interfering background graphics. As another example, a refined image may center or otherwise further clarify an area including one or more object markers.

As also illustrated in FIG. 6, method 600 may include a step 630 of analyzing the refined image using a machine learning model, the machine learning model being trained, using a plurality of object images, to recognize object markers in images received as input, and to identify one or more launch parameters based on the recognized object markers (as described herein). In some embodiments, the object(s) being analyzed in step 630 may be a golf ball, a golf club, or a golf ball and a golf club. A plurality of object images (for training the machine learning model) may include a diverse set of images used to train the machine learning model, and may include object marker variations (e.g., images of objects (e.g., golf balls or clubs) with different types of object markers, such as, e.g., painted patterns, reflective stickers or decals, or engraved or embossed features), object types (e.g., images of different types of objects used in the system, such as, e.g., golf balls with varying brands, sizes, textures, and marker types, golf club parts like the toe, hosel, and shaft, or accessories or tools relevant to the setup), environmental variations (e.g., images captured under different environmental conditions to ensure robustness, such as, e.g., indoor and outdoor settings, different weather conditions (e.g., sunny, cloudy, rainy, windy), or varying backgrounds (e.g., turf, sand, walls), lighting conditions (e.g., images with varying levels of lighting, such as, e.g., high glare or reflections, shadows or uneven illumination, or dim or overexposed conditions), motion or blur scenarios (e.g., images showing objects in motion or with motion blur to simulate real-world conditions), perspective or angles (e.g., images of objects captured from various angles, distances, or perspectives), object states (e.g., images of objects in different states or conditions, such as, e.g., worn or damaged surfaces (e.g., scuffed golf balls), or clean surfaces (e.g., new or pristine golf balls), noise or interference (e.g., images including potential interfering features), or special cases (e.g., images with complex or ambiguous markers to train the model on challenging scenarios, or simulated images with artificially added distortions or other interfering features for robustness or testing).

Further, as illustrated in FIG. 6, method 600 may include a step 640 of providing an output based on the identified object marker(s) or launch parameter(s). For example, in some embodiments system 204 may generate an output file in the form of a .CSV or a .TXT that includes information about the object marker and the launch parameters determined by the machine learning model. In some embodiments, the launch parameters may include a grade for a product associated with the object(s) and may also include information about identified object marker types in relation to the identified launch parameters.

In some embodiments, generating the refined image may further include decomposing the received image into spatial components and frequency components (as described herein). Spatial decomposition may involve breaking an image into its constituent regions or pixel-based details, as they appear in space (e.g., in the original layout of the received image). For example, the received image may be decomposed to be represented as a grid of pixel intensities (e.g., brightness or color values). Spatial decomposition may also aid in dividing an image into areas with shared characteristics, such as edges, textures, or regions of uniform intensity. Decomposing, as used herein, may refer to performing image segmentation (e.g., dividing the image into regions) or applying filters (e.g., edge detection algorithms) to isolate specific features. Frequency decomposition may involve analyzing an image based on the variations in intensity over distance, represented as different frequency components. Low-frequency components may correspond to slow changes, such as smooth gradients or large regions of similar color. High-frequency components may correspond to rapid changes, such as edges, fine details, or noise. It will be understood that spatial data may also be converted into frequency data, using, e.g., a Fourier transform or a Wavelet transform. It will be further understood that decomposing the received image into such components enables further insights based on the structure of the received image as well as the targeting of specific features (e.g., removing noise, enhancing object markers, or smoothing regions) for refinement or analysis.

In some embodiments, generating the refined image may include recovering a marker feature degraded by at least one of the interfering features associated with the received image (as described herein). Recovering may include, e.g., removing noise, restoring sharpness, or adjusting lighting, contrast, or gain. As an example, if the image shows a golf ball with a marker but the marker is partially obscured by a glare, recovering the marker feature may involve removing or minimizing the glare to recover the full visibility of the marker. As another example, if a club's hosel marker is blurred due to motion, recovering the marker feature may include applying deblurring techniques to restore the sharpness of the marker. As yet another example, if environmental noise (e.g., debris) obscures the marker, recovering the marker feature may involve cleaning at least part of the image to, e.g., isolate or highlight the marker.

In some embodiments, the machine learning model may further be trained to determine a type of the recognized object marker, and the method may further comprise outputting the one or more launch parameters and the type of the recognized object marker (as described herein). The determined type of marker may be used to, e.g., further contextualize the corresponding launch parameters, assist with multiple marker analysis and interpreting each marker properly, or verify accuracy by, e.g., validating the determined type of marker. As an example, a golf ball captured in an image may include multiple markers (e.g., one or more reflective dots for spin tracking and a painted line for trajectory tracking), and the machine learning model may recognize the reflective dot(s) as spin markers. Continuing the example, the machine learning model may then use the marker type recognition to calculate a spin rate based on the detected markers and output both the spin rate and the type of marker detected (e.g., spin rate=3,000 RPM; marker type: spin marker).

In some embodiments, the one or more launch parameters may be associated with a collision between the object and another object (as described herein). A collision may involve a significant exchange of force or energy over a short period of time, and as a result, complex interactions may occur over that short period of time. The interaction during a collision may also result in changes to the motion, shape, or energy of the objects involved. Images captured during this time period by an imaging device may thus provide valuable and instantaneous information, based on the object markers captured in the images, about the complex interactions occurring during this time period. As examples, the collision may involve a golf club (e.g., a clubface) striking a golf ball, a golf club striking the ground, a golf ball hitting another golf ball or another surface (e.g., ground, wall, sand, tree, water, or another environmental or man-made object), or a combination thereof. Images capturing the objects at the time of collision and for at least a short period thereafter (e.g., 1-3 seconds after collision) may be provided, as described herein, to accurately and efficiently detect object markers or launch parameters during these time periods.

In some embodiments, the one or more launch parameters may include at least one of a trajectory of the object (e.g., ball trajectory, including apex height and carry distance, or club path), a speed of the object (e.g., initial ball or club speed immediately after the collision, clubhead speed), a spin of the object (e.g., spin axis, or spin rate, including backspin, sidespin, or topspin), or an angle between two objects in the received image (e.g., the angle between a ball trajectory and a clubface; the orientation of the clubface at impact relative to a target line, such as open, closed, or square; or the angle at which a clubhead approaches a ball, relative to the ground). The launch parameters may also include a launch angle of the object (e.g., the angle of the object's trajectory relative to the ground immediately after collision), an impact location (e.g., the point on a clubface where a golf ball makes contact, such as the center, toe, or heel), an object impact force (e.g., an amount of force exerted on the object during collision), or a degree of deformation of the object (e.g., a degree of compression of a ball at collision).

In some embodiments, analyzing the refined image may comprise identifying a first object marker on a first object (as discussed herein). For example, the first object marker identified may be a marker on a golf ball, such as a circular ball marker or a centerline marker. In some embodiments, analyzing the refined image may further comprise identifying a second object marker on the first object or on a second object (as discussed herein). For example, the second object marker identified may be another marker on the golf ball, or a marker on a different object, such as a golf club. In some embodiments, identifying the one or more launch parameters may be based on the first object marker and the second object marker (as discussed herein). For example, the method may utilize the position, orientation, or motion of the first object marker relative to the second object marker in order to derive launch parameters. In some embodiments, an identified golf club marker (e.g., clubhead marker) and an identified ball marker may be compared or otherwise assessed together to determine impact conditions such as, e.g., collision angle or energy transfer). In some embodiments, two ball markers (located on the same ball), or the orientation thereof, may be compared or otherwise assessed together to analyze spin rate or axis by tracking rotational motion. The first and second identified object markers may thereby provide data about various launch parameters during and shortly after the collision (e.g., the first marker may provide information about initial velocity of a ball, and the second marker may help determine rotational properties or deformation parameters of the ball; or a first ball marker may indicate the ball's trajectory or spin, a second club marker may indicate a swing path or impact point, and combining the two markers may aid in calculating launch angle, spin rate, or energy transfer efficiency).

In some embodiments, the method may further comprise annotating the received image or the refined image to indicate at least one of a ball marker on a corresponding golf ball or golf club in the received image, or a particular launch parameter associated with the corresponding golf ball or golf club, and inputting the annotated image to the machine learning model as training data (as described herein). For example, the method may identify and mark a ball's position, track its trajectory or spin axis, or identify where the club strikes the ball, including impact details like attack angle or swing path. One purpose of annotating the image may be to provide visual feedback for users, ensuring that the locations of object markers and the corresponding launch parameters are clearly understood. Additionally, annotating may also help verify the accuracy of marker detection and the calculation of launch parameters, which is useful for training and testing machine learning models to improve their accuracy. Annotated images may also enable enhanced analysis by making it easier to interpret the dynamics of motion or interaction, by, e.g., offering a clearer representation of how markers influence performance or mechanical behavior. As another example, one or more image annotation tools may be utilized to draw bounding boxes, polygons, segmentation masks, or other informative symbols to highlight damage areas of the product, and these annotations may be exported as training data to be fed to a machine learning model using one or more frameworks or object detection models.

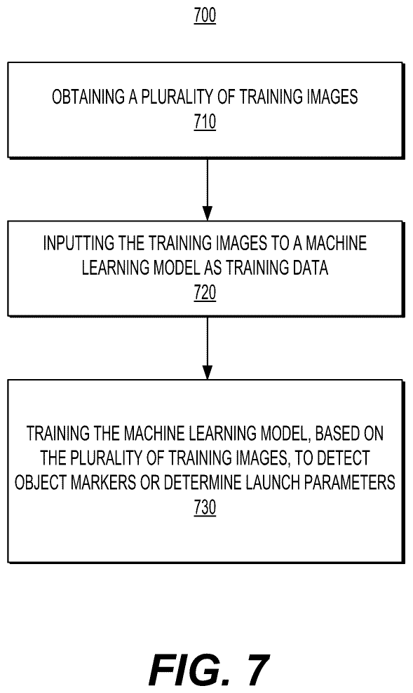

An exemplary method 700 for training a machine learning model, consistent with disclosed embodiments, is illustrated in FIG. 7. As illustrated in FIG. 7, exemplary method 700 may include a step 710 of obtaining a plurality of training images of objects having object markers or interfering features (as described herein). Training images may include, e.g., labeled images, unlabeled images, simulated or synthetic images, sequential images, noisy or degraded images, or other images that add to a knowledge base of information. For example, a machine learning model may obtain a series of images of a golf ball or golf club, before, during, and after a collision with the golf club (e.g., before, during, and after being struck by the golf club).

As further illustrated in FIG. 7, method 700 may include a step 720 of inputting the training images to the machine learning model as training data (as described herein). The training data may be input, e.g., by a systematic process that prepares the data, feeds it into the model, and thereby allows the model to learn from it. For example, inputting the training images may include batching the data into various sizes, utilizing a data loader, or transforming raw data into feature vectors or numerical arrays.

As also illustrated in FIG. 7, method 700 may include a step 730 of training the machine learning model, based on the plurality of training images, to detect object markers or identify launch parameters (as described herein). Training the machine learning model may include, e.g., forward propagation, backward propagation, loss calculation, optimization, various iterations or epochs, and validating generated data. As an example, a system process of forward propagation and backward propagation, with loss calculation, may be performed to train a machine learning model to detect object markers or identify launch parameters.

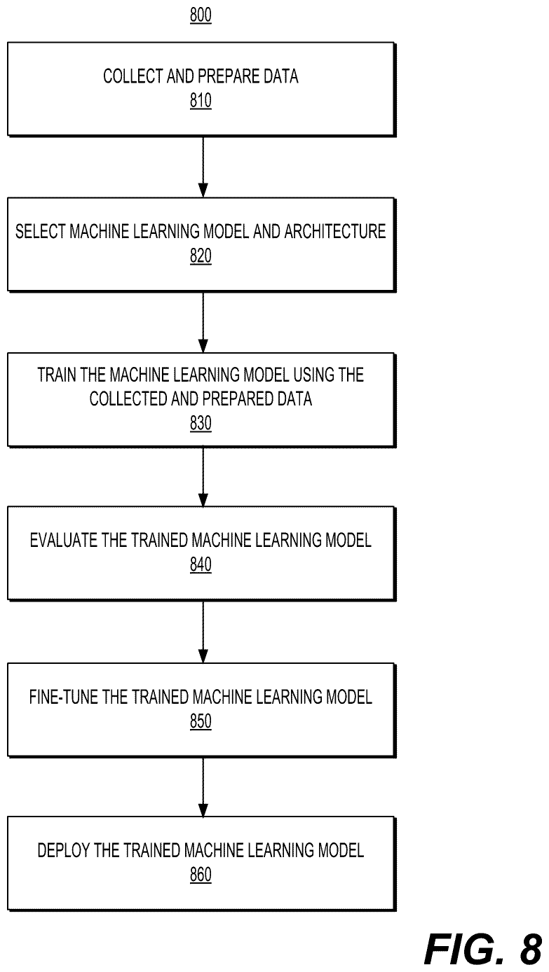

An exemplary method 800 for training a machine learning model, consistent with disclosed embodiments, is illustrated in FIG. 8. In some embodiments, the machine learning model may be trained and configured to detect object markers or identify launch parameters, as described herein. As illustrated in FIG. 8, exemplary method 800 may include a step 810 of collecting and preparing data. Collecting and preparing data may include, e.g., acquiring, accessing, or generating training data, cleaning and pre-processing data (e.g., handling missing values, normalizing data, or encoding categorical variables), and splitting data into training data sets and validation data sets. As further illustrated in FIG. 8, method 800 may also include a step 820 of selecting a machine learning model and architecture. Step 820 may include, e.g., selecting an appropriate machine learning algorithm or model type, defining the model architecture (e.g., number of layers, neurons, activation functions), and setting hyperparameters (e.g., learning rate, regularization). As also illustrated in FIG. 8, method 800 may further include a step 830 of training the machine learning model using the collected and prepared data. For example, step 830 may include initializing the machine learning model with random weights and biases, iterating over the training data (e.g., performing a forward pass, calculating the loss/error between predicted output and true output, and performing a backward pass), or repeating iteration until convergence or a predefined stopping criterion is met. Further, as shown in FIG. 8, method 800 may include a step 840 of evaluating the trained machine learning model. Step 840 may include, e.g., assessing the machine learning model's performance based on a validation data set (e.g., computing evaluation metrics such as accuracy, precision, recall, or F1-score, or analyzing results and adjusting model architecture). As also shown in FIG. 8, method 800 may include a step 850 of fine-tuning the trained machine learning model. As shown in FIG. 8, method 800 may also include a step 860 of deploying the trained machine learning model. For example, step 860 may include deploying the machine learning model to a production environment, monitoring the machine learning model's performance, updating the machine learning model as needed, or using the machine learning model to generate output based on a given input.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local or remote computer storage media including memory storage devices.

The embodiments discussed herein involve or relate to artificial intelligence (AI). AI may involve perceiving, synthesizing, inferring, predicting or generating information using computerized tools and techniques (e.g., machine learning). For example, AI systems may use a combination of hardware and software as a foundation for rapidly performing complex operation to perceive, synthesize, infer, predict, or generate information. AI systems may use one or more models, which may have a particular configuration (e.g., model parameters and relationships between those parameters, as discussed below). While a model may have an initial configuration, this configuration can change over time as the model learns from input data (e.g., training input data), which allows the model to improve its abilities. For example, a dataset may be input to a model, which may produce an output based on the dataset and the configuration of the model itself. Then, based on additional information (e.g., an additional input dataset, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously navigate vehicles, automatically recognize objects, instantly generate natural language, understand human speech, and generate artistic images. The results of the embodiments discussed herein further show that AI systems can be configured to assess product damage with more accuracy, at a greater speed, and without implementing as many human resources, if any. Furthermore, the AI systems described herein improve the processing speed of the processor(s) and computing device disclosed herein. For example, by generating more accurate and objective scores for each product image using an AI system (e.g., a machine learning model), the processor(s) or computing device(s) is improved by receiving such scores from the machine learning model and taking further steps (e.g., performing further analysis) using the received scores (as compared, e.g., to the processor(s) or computing device(s) receiving subjective and skewed scores from human individuals or other subjective methods instead).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

It will be apparent to those skilled in the art that various modifications and variations can be made to the disclosed embodiments of the launch monitor. Other embodiments will be apparent to those skilled in the art from consideration of the specification and practice of the disclosed launch monitor. Therefore, it will be understood that the appended claims are intended to cover all such modifications and embodiments, which would come within the spirit and scope of the present disclosure.

What is claimed is:

1. A system for identifying launch parameters, the system comprising:
an imaging device;
at least one memory storing instructions; and
at least one processor configured to execute the instructions to perform operations for identifying launch parameters, the operations comprising:
receiving an image of an object captured by the imaging device;
generating a refined image based on the received image, the refined image correcting one or more interfering features associated with the received image; and
analyzing the refined image using a machine learning model, the machine learning model being trained using a plurality of object images to:
recognize object markers in images received as input; and
identify one or more launch parameters based on the recognized object markers.

2. The system of claim 1, wherein the operations further comprise:
training the machine learning model, wherein the training comprises:
obtaining a plurality of training images, each training image including one or more training object markers;
inputting the plurality of training images to the machine learning model as training data; and
training the machine learning model, based on the plurality of training images, to recognize object markers in a received image and determine one or more launch parameters based on the recognized object markers.

3. The system of claim 2, wherein generating the refined image further includes decomposing the received image into spatial components and frequency components.

4. The system of claim 3, wherein generating the refined image includes recovering a marker feature degraded by at least one of the environmental conditions, lighting conditions, or blurring associated with the received image.

5. The system of claim 1, wherein the machine learning model is further trained to determine a type of the recognized object marker, and the operations further comprise outputting the one or more launch parameters and the type of the recognized object marker.

6. The system of claim 1, wherein the one or more launch parameters are associated with a collision between the object and another object.

7. The system of claim 1, wherein the one or more launch parameters include at least one of a trajectory of the object, a speed of the object, a spin of the object, or an angle between two objects in the received image.

8. The system of claim 1, wherein:
analyzing the refined image comprises:
identifying a first object marker on a first object; and
identifying a second object marker on the first object or on a second object; and
identifying the one or more launch parameters is based on the first object marker and the second object marker.

9. The system of claim 1, the operations further comprising:
annotating the received image or the refined image to indicate at least one of:
a ball marker or a club marker in the received image; or
a particular launch parameter associated with identified positions of the ball marker or the club marker; and
inputting the annotated image to the machine learning model as training data.

10. The system of claim 9, wherein the annotated image:
includes the ball marker indication and the particular launch parameter indication; and
further indicates an association between the ball marker and the particular launch parameter.

11. The system of claim 1, the operations further comprising:
inputting fine-tuning data to the machine learning model; and
further training the machine learning model using the fine-tuning data, wherein the fine-tuning data indicates an association between received training data and one or more interfering features within the received training data.

12. A method for identifying launch parameters, the method comprising:
receiving an image of an object captured by an imaging device;
generating a refined image based on the received image, the refined image correcting one or more interfering features associated with the received image; and
analyzing the refined image using a machine learning model, the machine learning model being trained, using a plurality of object images, to:
recognize object markers in images received as input; and
identify one or more launch parameters based on the recognized object markers.

13. The method of claim 12, wherein generating the refined image further includes decomposing the received image into spatial components and frequency components.

14. The method of claim 12, wherein generating the refined image includes recovering a marker feature degraded by at least one of the interfering features associated with the received image.

15. The method of claim 12, wherein the machine learning model is further trained to determine a type of the recognized object marker, and the method further comprises outputting the one or more launch parameters and the type of the recognized object marker.

16. The method of claim 12, wherein the one or more launch parameters are associated with a collision between the object and another object.

17. The method of claim 12, wherein the one or more launch parameters include at least one of a trajectory of the object, a speed of the object, a spin of the object, or an angle between two objects in the received image.

18. The method of claim 12, wherein:
analyzing the refined image comprises:
identifying a first object marker on a first object; and
identifying a second object marker on the first object or on a second object; and
identifying the one or more launch parameters is based on the first object marker and the second object marker.

19. The method of claim 12, further comprising:
annotating the received image or the refined image to indicate at least one of:
a ball marker on a corresponding golf ball or golf club in the received image; or
a particular launch parameter associated with the corresponding golf ball or golf club; and
inputting the annotated image to the machine learning model as training data.

20. A networked device comprising one or more processors to perform operations for identifying launch parameters, the operations comprising:
receiving an image of an object captured by an imaging device;
generating a refined image based on the received image, the refined image correcting one or more interfering features associated with the received image; and
analyzing the refined image using a machine learning model, the machine learning model being trained, using a plurality of object images, to:
recognize object markers in images received as input; and
identify one or more launch parameters based on the recognized object markers.
